(19) United States
(12) Patent Application Publication
(10) Pub. No.: US 2020/0070519 A1
(43) Pub. Date: Mar. 5, 2020

(54) METHOD FOR PRODUCING POROUS BODY, POROUS BODY, AND INKJET RECORDING APPARATUS

(71) Applicant: CANON KABUSHIKI KAISHA, Tokyo (JP)

(72) Inventor: Yasuaki Tominaga, Kawasaki-shi (JP)

(21) Appl. No.: 16/551,472

(22) Filed: Aug. 26, 2019

(30) Foreign Application Priority Data
Aug. 31, 2018 (JP) 2018-163657

(51) Int. Cl. B41J 2/165; B32B 5/02; B32B 5/26; B32B 37/15; B32B 38/00; B32B 7/027; D01D 5/00; D01D 10/02

(52) U.S. Cl. CPC B41J 2/16505; B32B 2309/02; B32B 5/26; B32B 37/15; B32B 38/0036; B32B 7/027; D01D 5/0007; D01D 10/02; B32B 2250/02; B32B 2250/20; B32B 2250/246; B32B 2262/0238; B32B 2305/20; B32B 2307/54; B32B 2327/18; B32B 5/022

(57) ABSTRACT

A method for producing a porous body having a first porous layer and a second porous layer on the first porous layer. The volume ratio of the first resin to the second resin in the first porous layer is 1:1 to 200:1. A heating temperature in performing a first heat treatment is higher than or equal to the softening point of the first resin. A heating temperature in performing a second heat treatment is higher than or equal to the softening point of the second resin but lower than the softening point of the first resin.

### BACKGROUND OF THE INVENTION

### Field of the Invention

The present disclosure relates to a method for producing a porous body, a porous body, and an inkjet recording apparatus.

### Description of the Related Art

According to an inkjet recording method, an image (ink image) is formed by applying an ink containing a coloring material to a record medium such as a sheet of paper. During this process, the record medium may absorb excess amounts of liquid components in the ink, and curling and cockling may occur as a result.

In order to rapidly remove liquid components in the ink, a method that involves drying a record medium by infrared rays and the like, and a method that involves drying liquid components in an ink image formed on a transfer body by heat energy or the like and then transferring the ink image onto a record medium such as a sheet of paper have been available.

Japanese Patent Laid-Open No. 2009-45851 proposes use of a porous body instead of heat energy to remove the liquid component contained in an ink image on a transfer body, and discloses a method for removing the liquid component from the ink image by causing the porous body to contact the ink image.

This porous body used to remove the liquid components needs to be further improved in order to achieve high levels of both liquid absorbency, which is an ability to absorb the liquid component from an ink image, and a filtering property, which is an ability to prevent solid components such as a pigment contained in the ink image from entering the porous body. In addition, in order to reduce deterioration of the porous body caused by the load applied to the porous body when the porous body is pressed by a pressing member and brought into contact with a transfer body, the porous body is required to have high mechanical strength.

For air filters for dust removal, there is known a technique for achieving both air permeability and the filtering property. This technique involves forming a multilayer structure that includes a thin filtering layer having a small pore diameter and a high flow resistance, and an air permeable supporting member disposed on the thin filtering layer, the air permeable supporting member having a large pore diameter and a low flow resistance. However, adhesion between the filtering layer and the air permeable supporting member is often insufficient, and the filtering layer tends to detach during processing or use of the filtering element.

To address this issue, Japanese Patent Laid-Open No. 2006-150275 proposes a method for improving adhesion without degrading air permeability. This method involves placing, between a polytetrafluoroethylene porous film and an air permeable supporting member, an air permeable, thermal bonding member constituted by two layers having different softening points, and then performing a heat treatment thereon.

Japanese Patent Laid-Open No. 2013-155450 proposes forming a composite nanofiber aggregate that contains a first polymer having a first melting point and a second polymer having a second melting point lower than the first melting point, and heating the composite nanofiber aggregate to a temperature lower than the first melting point but higher than the second melting point. According to this method, a structure in which first nanofibers composed of the first polymer are partly bonded to one another by the second polymer is formed to prepare a high-strength composite nanofiber aggregate and increase the mechanical strength of the fiber aggregate.

### SUMMARY OF THE INVENTION

The present disclosure is directed to providing a method for producing a porous body including two or more porous layers stacked on top of each other, by which a porous body having high liquid permeability and high mechanical strength can be produced. The present disclosure is also directed to providing a porous body obtained by the aforementioned method for producing a porous body, and an inkjet recording apparatus that includes the porous body.

An aspect of the present disclosure provides a method for producing a porous body that includes a first porous layer and a second porous layer on the first porous layer. The method includes forming a composite fiber aggregate by an electrospinning method, the composite fiber aggregate having a first fiber containing a first resin and a second fiber containing a second resin having a softening point lower than a softening point of the first resin; after forming the composite fiber aggregate, performing a first heat treatment on the composite fiber aggregate; after performing the first heat treatment, forming, by an electrospinning method, a fiber aggregate on the composite fiber aggregate subjected to the first heat treatment, the fiber aggregate containing the second resin; and after forming the fiber aggregate, performing a second heat treatment on a multilayer body that includes the composite fiber aggregate subjected to the first heat treatment and the fiber aggregate. A volume ratio of the first resin to the second resin in the first porous layer is 1:1 to 200:1. A heating temperature in the performing of the first heat treatment is higher than or equal to the softening point of the first resin. A heating temperature in the performing of the second heat treatment is higher than or equal to the softening point of the second resin but lower than the softening point of the first resin.

Another aspect of the present disclosure provides a porous body that includes a first porous layer; and a second porous layer on the first porous layer. The porous body is obtained by forming a composite fiber aggregate by an electrospinning method, the composite fiber aggregate having a first fiber containing a first resin and a second fiber containing a second resin having a softening point lower than a softening point of the first resin; after forming the composite fiber aggregate, performing a first heat treatment on the composite fiber aggregate; after performing the first heat treatment, forming, by an electrospinning method, a fiber aggregate on the composite fiber aggregate subjected to the first heat treatment, the fiber aggregate containing the second resin; and after forming the fiber aggregate, performing a second heat treatment on a multilayer body that includes the composite fiber aggregate subjected to the first heat treatment and the fiber aggregate. A volume ratio of the first resin to the second resin in the first porous layer is 1:1 to 200:1. A heating temperature in the performing of the first heat treatment is higher than or equal to the softening point of the first resin. A heating temperature in the performing of the second heat treatment is higher than or equal to the softening point of the second resin but lower than the softening point of the first resin.

Yet another aspect of the present disclosure provides an inkjet recording apparatus that includes an image forming unit that forms a first image on an ejection-receiving medium, the first image containing a liquid component and a coloring material; and a liquid absorbing member including a porous body, and absorbing at least part of the liquid component from the first image by bringing the porous body into contact with the first image. The porous body includes a first porous layer; and a second porous layer on the first porous layer, and is obtained by forming a composite fiber aggregate by an electrospinning method, the composite fiber aggregate having a first fiber containing a first resin and a second fiber containing a second resin having a softening point lower than a softening point of the first resin; after forming the composite fiber aggregate, performing a first heat treatment on the composite fiber aggregate; after performing the first heat treatment, forming, by an electrospinning method, a fiber aggregate on the composite fiber aggregate subjected to the first heat treatment, the fiber aggregate containing the second resin; and after forming the fiber aggregate, performing a second heat treatment on a multilayer body that includes the composite fiber aggregate subjected to the first heat treatment and the fiber aggregate. A volume ratio of the first resin to the second resin in the first porous layer is 1:1 to 200:1, a heating temperature in the performing of the first heat treatment is higher than or equal to the softening point of the first resin, and a heating temperature in the performing of the second heat treatment is higher than or equal to the softening point of the second resin but lower than the softening point of the first resin.

Further features of the present disclosure will become apparent from the following description of exemplary embodiments with reference to the attached drawings.

### BRIEF DESCRIPTION OF THE DRAWINGS

FIGS. 1A to 1C are schematic diagrams illustrating changes in structure during heating of a composite nanofiber aggregate.

FIG. 2 is a schematic diagram illustrating an overall structure of an electrospinning apparatus used in one embodiment of the present disclosure.

FIGS. 3A to 3D are cross-sectional views of fiber aggregates in respective steps of a method for producing a porous body according to one embodiment of the present disclosure.

FIG. 4 is a schematic diagram illustrating a structure of a transfer-type inkjet recording apparatus according to one embodiment of the present disclosure.

### DESCRIPTION OF THE EMBODIMENTS

A porous film described in Japanese Patent Laid-Open No. 2006-150275 is formed by stacking the layers by a typical heat lamination method; thus, the heating temperature for lamination needs to be increased to improve the adhesion between the layers in order to obtain a desired mechanical strength. However, increasing the heating temperature tends to clog pores (also referred to as voids or gaps) in the porous film and sometimes degrades air permeability of the obtained porous film.

According to a production method described in Japanese Patent Laid-Open No. 2013-155450, a composite nanofiber aggregate having a structure in which first nanofibers composed of a first polymer are partly bonded to one another by a second polymer is formed; however, the desired mechanical strength is not always exhibited. Even when a method of stacking two or more layers of porous bodies is employed from the viewpoint of air permeability, the desired mechanical strength is not always exhibited. The mechanical strength of this composite nanofiber aggregate is examined. It has been found that the mechanical strength of the composite nanofiber aggregate is sometimes lower than both the mechanical strength of a fiber aggregate composed of the first polymer alone and the mechanical strength a fiber aggregate composed of the second polymer alone.

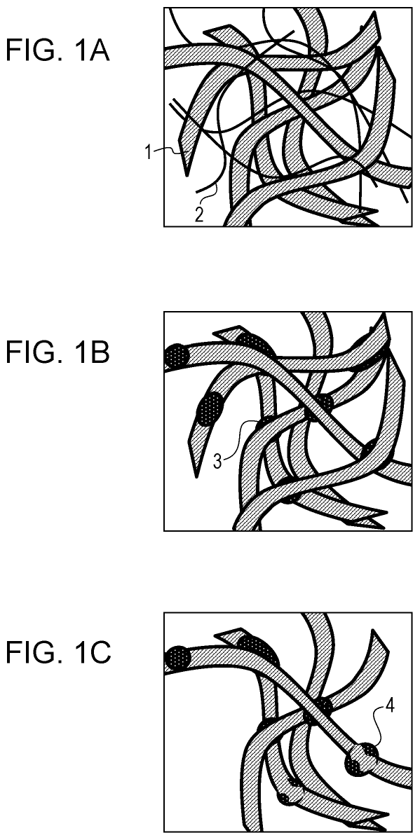

The inventors of the present disclosure have investigated the cause therefor and found the following. Although the first nanofibers were partly bonded to one another via the second nanofibers that had melted due to the heat treatment, the load applied to the composite nanofiber aggregate sometimes caused the second nanofibers bonding the first nanofibers to one another to detach from the bonding sites of the first nanofibers. The detachment of the second nanofibers will now be described by using schematic diagrams of FIGS. 1A to 1C illustrating changes in structure during heating of the composite nanofiber aggregate. FIG. 1A is a schematic diagram illustrating a structure of a composite nanofiber aggregate that contains first nanofibers and second nanofibers before the heat treatment. FIG. 1B is a schematic diagram illustrating a structure of a high-strength composite nanofiber aggregate that is formed by heating the composite nanofiber aggregate to a temperature lower than the first melting point but higher than the second melting point and that has a structure in which the first nanofibers are bonded to one another thorough the second polymer. FIG. 1C is a schematic diagram illustrating a structure in which some of the bonds between the first nanofibers are lost due to the load applied to the obtained high-strength composite nanofiber aggregate. In Japanese Patent Laid-Open No. 2013-155450, as illustrated in FIG. 1A, a composite nanofiber aggregate composed of first nanofibers 1 and second nanofibers 2 are formed first. The composite nanofiber aggregate is then heated to form a high-strength composite nanofiber aggregate in which the first nanofibers 1 are partly bonded to one another through second nanofibers 3 (second polymer) that have melted due to the heating treatment as illustrated in FIG. 1B. The bonds between the melted second nanofibers 3 and the first nanofibers may become insufficient depending on the types of the polymers constituting the second nanofibers 3 and the first nanofibers. Thus, when a load was applied to the high-strength composite nanofiber aggregate, as illustrated in FIG. 1C, the first nanofibers 1 detached from the melted second nanofibers 3, detached portions 4 occurred, and thus the desired mechanical strength was not obtained.

Accordingly, it is considered to be difficult to produce, by the method for producing the porous body described in Japanese Patent Laid-Open No. 2009-45851, a porous body having high liquid permeability and high mechanical strength by employing the techniques described in Japanese Patent Laid-Open Nos. 2006-150275 and 2013-155450.

The present disclosure will now be described in detail through preferable embodiments with reference to the drawings.

### Method for Producing Porous Body

A method for producing a porous body according to the present disclosure includes the following steps in order to form a porous body that has a first porous layer and a second porous layer on the first porous layer.

A step of forming, by an electrospinning method, a composite fiber aggregate having first fibers containing a first resin and second fibers containing a second resin having a softening point lower than that of the first resin (composite fiber aggregate forming step).

A step of performing a first heat treatment on the composite fiber aggregate (first heat treatment step).

A step of forming, by an electrospinning method, a fiber aggregate containing the second resin on the composite fiber aggregate subjected to the first heat treatment (fiber aggregate forming step).

A step of performing a second heat treatment on a multilayer body that includes the composite fiber aggregate subjected to the first heat treatment and the fiber aggregate (second heat treatment step).

The volume ratio of the first resin to the second resin in the first porous layer of the porous body is set to 1:1 to 200:1. Furthermore, the heating temperature in the step of performing the first heat treatment is set to a temperature higher than or equal to the softening point of the first resin, and the heating temperature in the step of performing the second heat treatment is set to a temperature higher than or equal to the softening point of the second resin but lower than the softening point of the first resin.

The aforementioned respective steps will now be described with reference to the drawings.

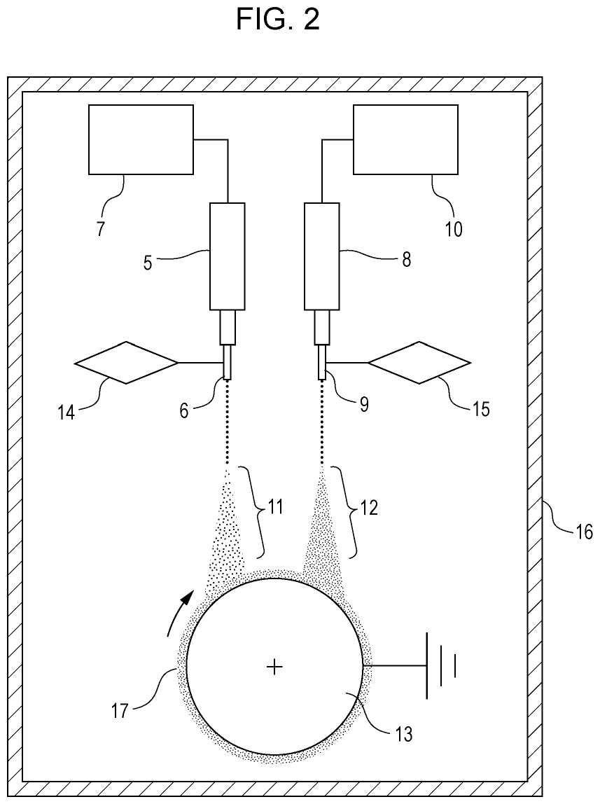

FIG. 2 is a schematic diagram illustrating an overall structure of an electrospinning apparatus used in a method for producing a fiber aggregate according to this embodiment.

A solution electrospinning method that uses a solution prepared by dissolving a resin in a solvent and a melt electrospinning method that uses a resin melted by heat are available as the electrospinning method. A solution electrospinning method that can form fine fibers can be used here. This is because smaller fiber diameters improve the filtering property. A solution electrospinning method involves causing an electric field to act on a resin solution supplied to a spinning space from a resin solution supplying unit, such as a nozzle, so as to stretch the resin and form the resin into fibers.

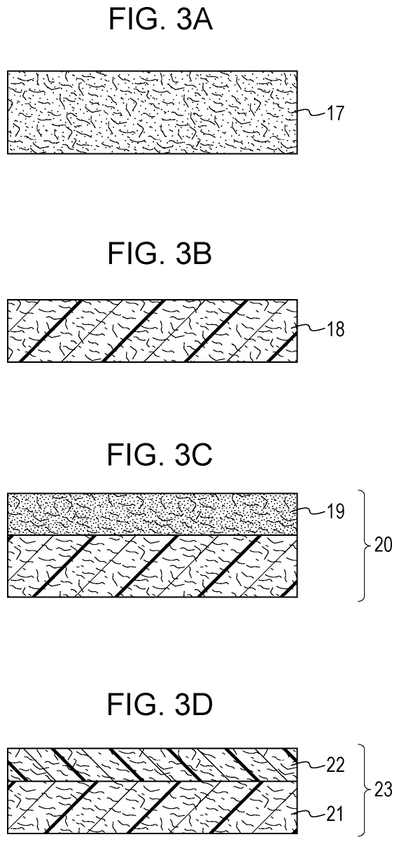

FIGS. 3A to 3D are cross-sectional views of fiber aggregates in respective steps of a method for producing a porous body according to this embodiment.

### Composite Fiber Aggregate Forming Step

FIG. 3A is a cross-sectional view of a composite fiber aggregate 17 having first fibers and second fibers formed by the electrospinning apparatus illustrated in FIG. 2.

As illustrated in FIG. 2, the electrospinning apparatus of this embodiment is quipped with a first resin solution supplying device 7 that supplies a first resin solution 5 containing a first resin to a first nozzle 6. The electrospinning apparatus is also quipped with a second resin solution supplying device 10 that supplies a second resin solution 8 containing a second resin to a second nozzle 9. The electrospinning apparatus forms first fibers 11 that contain the first resin ejected from the first nozzle 6 and stretched by an electric field, and second fibers 12 that contain the second resin ejected from the second nozzle 9. The electrospinning apparatus is equipped with an earthed collector 13 for collecting the first fibers 11 and the second fibers 12. The electrospinning apparatus is also equipped with a first voltage applying device 14 and a second voltage applying device 15 that respectively form electric fields between the first nozzle 6 and the collector 13 and between the second nozzle 9 and the collector 13. The electrospinning apparatus is equipped with a spinning chamber 16 for keeping the spinning space constant, an air conditioner for adjusting the temperature and the humidity inside the spinning chamber, an air inlet port, and an evacuation port through which the solvent evaporated in the spinning space is discarded (not illustrated). A composite fiber aggregate 17 is formed on the collector 13.

In order to form fibers by using such an apparatus, a first resin solution 5 prepared by dissolving the first resin in a solvent and a second resin solution 8 prepared by dissolving the second resin in a solvent are prepared.

In the present disclosure, the softening point of the second resin is lower than the softening point of the first resin. The softening point of the first resin can be 10° C. or more higher than the softening point of the second resin. When the softening point of the first resin is 10° C. or more higher than the softening point of the second resin, the first fibers contained in the composite fiber aggregate subjected to the first heat treatment do not readily soften during the step of performing the second heat treatment. Thus, the liquid permeability and the mechanical strength of the porous body having the first porous layer and the second porous layer further improve. The softening point of the first resin can be 30° C. or more higher than the softening point of the second resin since the porous body is rarely affected by variation in the step of performing the heat treatments.

The upper limit of the softening point of the first resin is not particularly limited but can be 200° C. or lower. When the softening point of the first resin is 200° C. or lower, changes in properties of the second resin contained in the composite fiber aggregate that occur by heat during the first heat treatment can be suppressed. The softening point of the first resin is preferably 120° C. or higher and 160° C. or lower and more preferably 135° C. or higher and 150° C. or lower.

The softening point of the second resin is preferably 40° C. or higher and 140° C. or lower and more preferably 50° C. or higher and 130° C. or lower.

Examples of the first resin and the second resin include, but are not limited to, polyacrylonitrile, polycarbonate, polyethylene, polypropylene, polyethylene oxide, polyethylene glycol, polyethylene terephthalate, polyethylene naphthalate, poly-m-phenylene terephthalate, poly-p-phenylene isophthalate, polymethacrylic acid, polymethyl methacrylate, polyvinyl chloride, a polyvinylidene chloride-acrylate copolymer, polyvinyl alcohol, polyvinyl pyrrolidone, polyarylate, polyacetal, polystyrene, polysulfone, polyether sulfone, polyphenyl sulfone, polyphenylene sulfide, polyamide, polyimide, polyamideimide, polyaramid, polyimide benzazole, polybenzimidazole, polyglycolic acid, polylactic acid, polyurethane, cellulose compounds, polypeptides, polynucleosides, polynucleotides, proteins, and enzymes.

The second resin can contain a fluororesin having a low surface free energy from the viewpoint of enhancing the cleaning property and suppressing adhesion of a coloring material when the porous body is used as a liquid absorbing member of an inkjet recording apparatus. Examples of the fluororesin include, but are not limited to, polytetrafluoroethylene (PTFE), polychlorotrifluoroethylene (PCTFE), polyvinylidene fluoride (PVDF), polyvinyl fluoride (PVF), perfluoroalkoxy fluororesins (PFA), tetrafluoroethylene-hexafluoropropylene copolymers (FEP), ethylene-tetrafluoroethylene copolymers (ETFE), ethylene-chlorotrifluoroethylene copolymers (ECTFE), poly (vinylidene fluoride-co-hexafluoropropylene) (PVDF-HFP), and tetrafluoroethylene-hexafluoropropylene-vinylidene difluoride copolymers (PTFE-HFP-VDF). These resins may be used alone or in combination as a mixture.

The first resin can have a tensile modulus of 1500 MPa or more. When the first resin has a tensile modulus of 1500 MPa or more and when the porous body is used as a liquid absorbing member of an inkjet recording apparatus, the porous body does not readily collapse by coming into contact with an image before removal of the liquid component, and the liquid component in the image can be more efficiently absorbed.

The first resin and the second resin preferably each have a weight-average molecular weight of 10,000 to 1,000,000 and more preferably 100,000 to 500,000. The fibrous resins can be easily formed by the electrospinning method by adjusting the weight-average molecular weights of the resins to be within the aforementioned range.

The solvent contained in the first resin solution 5 and the second resin solution 8 may be any solvent that can dissolve the resins. Examples of the solvent include, but are not limited to, water, acetone, methyl isobutyl ketone, diisobutyl ketone, acetophenone, ethyl acetate, butyl acetate, methanol, ethanol, propanol, isopropanol, hexafluoroisopropanol, tetrahydrofuran, dimethyl sulfoxide, 1,4-dioxane, pyridine, N,N-dimethylformamide, N,N-dimethylacetamide, N-methyl-2-pyrrolidone, acetonitrile, formic acid, toluene, benzene, cyclohexane, cyclohexanone, carbon tetrachloride, methylene chloride, chloroform, trichloroethane, ethylene carbonate, diethyl carbonate, and propylene carbonate. These solvents may be used alone or in combination as a mixture.

Appropriate additives may be added to the first resin solution 5 and the second resin solution 8 if needed. Examples of the additive include, but are not limited to, salts such as lithium chloride, lithium bromide, and sodium chloride, and surfactants.

The resin concentrations in the first resin solution 5 and the second resin solution 8 are changed according to the type of resin, the molecular weight of the resin, the solvent, etc., but can be 1 to 50 mass % from the viewpoint of applicability to the electrospinning method. When the resin concentrations are within the aforementioned range, solvent evaporation and resin dissolution become sufficient, and thus the fibrous resins can be more smoothly formed.

As illustrated in FIG. 2, the first resin solution 5 and the second resin solution 8 are respectively supplied to the first nozzle 6 and the second nozzle 9 by the first resin solution supplying device 7 and the second resin solution supplying device 10. The supplied first resin solution 5 and second resin solution 8 are pushed out of the first nozzle 6 and the second nozzle 9. At the same time, the first voltage applying device 14 and the second voltage applying device 15 apply voltage to the nozzles 6 and 9 to generate electric fields between the earthed collector 13 and each nozzle, and the resins are jet out toward the collector 13 while being formed into fibers by the stretching action of these electric fields. The first fibers 11 and second fibers 12 jet out from the nozzles are collected on the collector 13 and form a composite fiber aggregate 17. The first resin solution supplying device 7 and the second resin solution supplying device 10 are not particularly limited, and, for example, a syringe pump, a tube pump, or a dispenser can be used.

The diameters (inner diameters) of the first nozzle 6 and the second nozzle 9 are adjusted according to the fiber diameter of the fibers to be obtained and are not particularly limited; for example, the diameters (inner diameters) can be 0.1 to 2.0 mm. The first nozzle 6 and the second nozzle 9 may be composed of a metal or a non-metal. When the first nozzle 6 and the second nozzle 9 are composed of a metal, the first nozzle 6 and the second nozzle 9 can each be used as one of electrodes. Thus, voltage can be applied to these electrodes from the first voltage applying device 14 and the second voltage applying device 15 so that the electric fields can act on the pushed-out resin solutions. When the first nozzle 6 and the second nozzle 9 are composed of a non-metal, electrodes must be installed inside the first nozzle 6 and the second nozzle 9 or inside supply ducts that respectively extend from the first resin solution supplying device 7 to the first nozzle 6 and from the second resin solution supplying device 10 to the second nozzle 9. Thus, voltage can be applied to these electrodes from the first voltage applying device 14 and the second voltage applying device 15 so that the electric fields can act on the pushed-out resin solutions.

In FIG. 2, electric fields are formed by applying voltage to the first nozzle 6 and the second nozzle 9 from the first voltage applying device 14 and the second voltage applying device 15 and, at the same time, earthing the collector 13. However, unlike in FIG. 2, the first nozzle 6 and the second nozzle 9 may be earthed and voltage may be applied to the collector 13 to form electric fields. Moreover, voltage may be applied to all of the first nozzle 6, the second nozzle 9, and the collector 13 in such a manner that a potential difference is formed so as to form electric fields.

The first voltage applying device 14 and the second voltage applying device 15 are not particularly limited, and, for example, DC high-voltage generators and Van de Graaff generators can be used. The applied voltage is not particularly limited and can be −30 to 50 kV. The potential difference between the first nozzle 6 and the collector 13 and between the second nozzle 9 and the collector 13 can be 5 to 80 kV.

In FIG. 2, the collector 13 is equipped with a cylindrical-shaped rotating mechanism; however, the collector 13 may be any structure that can collect fibers and is not particularly limited. For example, a nonwoven fabric, a woven fabric, a knit, a net, a flat plate, or a belt composed of a conductive material, such as metal or carbon, or a non-conductive material formed of an organic polymer or the like can be used as the collector 13.

The distances between the tip of the first nozzle 6 and the collector 13 and between the tip of the second nozzle 9 and the collector 13 are changed according to the fiber diameter of the fibers to be obtained and the boiling point of the solvent, and are not particularly limited; for example, the distances can be 5 to 50 cm. The distances between the tip of the first nozzle 6 and the collector 13 and between the tip of the second nozzle 9 and the collector 13 mean shortest distances from the tip of the first nozzle and the surface the collector and between the tip of the second nozzle and the surface of the collector.

The amounts of the supplied first resin solution 4 and second resin solution 9 are changed according to the fiber diameter of the fibers to be obtained, the type of the resin, the molecular weight of the resin, the solvent, etc., but can be 0.01 ml/h to 10 ml/h per nozzle from the viewpoint of applicability to electrospinning. When the amounts of the supplied resin solutions are within the aforementioned range, solvent evaporation and stretching satisfactorily occur, and thus the fibrous resins can be more smoothly formed.

In FIG. 2, one first nozzle 6 that supplies the first resin solution 5 and one second nozzle 9 that supplies the second resin solution 8 are provided; however, more than one nozzle may be placed side-by-side to increase productivity.

In the present disclosure, the average fiber diameter of the fibers is preferably 0.1 μm or more and 10.0 μm or less, more preferably 0.1 μm or more and 5.0 μm or less, and yet more preferably 0.1 μm or more and 3.0 μm or less. The first fibers can be thicker than the second fibers. When the first fibers are thicker than the second fibers, the mechanical strength and the filtering property are improved. The fiber diameter can be measured by, for example, SEM observation from the surface or SEM observation after a section is formed by an ion milling apparatus, a focused ion beam apparatus (FIB), or the like. In the present disclosure, the diameters of clearly identifiable fibers in ten positions in SEM photographs are measured, and the average calculated therefrom is determined to be the fiber diameter.

FIG. 2 illustrates a method for forming a composite fiber aggregate by operating the resin solution supplying devices and the voltage applying devices associated with both the first resin solution 5 and the second resin solution 8. Alternatively, a fiber aggregate formed of single resin can be formed by operating a resin solution supplying device and a voltage applying device associated with one of the resin solutions.

### First Heat Treatment Step

Next, the composite fiber aggregate 17 is subjected to a first heat treatment so as to obtain a composite fiber aggregate 18 subjected to the first heat treatment illustrated in FIG. 3B.

The first heating temperature in the step of performing the first heat treatment is higher than or equal to the softening point of the first resin. When the first heating temperature is lower than the softening point of the first resin, the fibers containing the first resin do not bond to one another and thus the mechanical strength is degraded. The upper limit of the first heating temperature is not particularly limited, but can be 200° C. or lower. When the first heating temperature is 200° C. or lower, changes in properties caused by heat damage on the second resin contained in the composite fiber aggregate can be suppressed. Moreover, the difference between the first heating temperature and the softening point of the first resin is preferably 0° C. or more and 20° C. or less and more preferably 5° C. or more and 15° C. or less.

During the heat treatment, the composite fiber aggregate 17 may be additionally subjected to a pressurizing treatment. In other words, the first heat treatment may be a heating and pressurizing treatment. This is because heating and pressurizing the composite fiber aggregate 17 increase the contact area between the fibers, and the fibers readily bond to one another. However, excessive pressurizing reduces the gaps and degrades the liquid permeability; thus, the pressure is preferably 0.1 kg/cm² or more and 10 kg/cm² or less and more preferably 0.1 kg/cm² or more and 5 kg/cm² or less.

Examples of the heating device that can be used include a hot air drier, an oven, an infrared heating device, and a microwave heating device. When pressurizing is to be additionally performed, a flat pressing machine, a roll pressing machine, a laminating machine, or a calendering machine equipped with a heating mechanism can be used as appropriate, for example.

It is critical that the volume ratio of the first resin to the second resin in the obtained composite fiber aggregate 18 subjected to the first heat treatment be 1:1 to 200:1. When the volume ratio of the first resin to the second resin is more than 200:1, the second resin present in a first porous layer 21 in the porous body is scarce, and thus the mechanical strength at the interface between the first porous layer 21 and a second porous layer 20 formed on the surface of the first porous layer 21 may be degraded. When the volume ratio of the first resin to the second resin is less than 1:1, the second resin present in the first porous layer 21 is abundant, and the melted second resin contained in the first porous layer 21 clogs the pores. Thus, the liquid permeability of the porous body may be degraded. The volume ratio of the first resin to the second resin in the composite fiber aggregate 18 subjected to the first heat treatment can be 2:1 to 100:1 since the porous body is not easily affected by variation during the heat treatment steps.

In the present disclosure, the volume ratio is a ratio of the resin volume calculated from the following formula (1) using the concentrations of the resin solutions, the amounts of the resin solutions supplied, the specific gravity of each resin solution, and the specific gravity of each resin.

(Resin volume)={(concentration of resin solution)×(amount of resin solution supplied×specific gravity of resin solution)}/(specific gravity of resin) (1)

In the present disclosure, the specific gravity of the resin solution is calculated from formula (2) below by using the specific gravity of the resin, the specific gravity of the solvent, and the mixing ratio. In some cases, the additive property is not established depending on the resin and the solvent, but such cases are ignored in the present disclosure.

(Specific gravity of resin solution)=Σ(specific gravity of component i and mixing ratio of component i) (2)

The resin volume is calculated for each of the first resin and the second resin contained in the composite fiber aggregate 18 subjected to the first heat treatment, and the ratio of the volume of the first resin to the volume of the second resin is determined as the volume ratio.

The ratio of the first resin to the second resin in the thickness direction of the composite fiber aggregate 17 may be constant or varied as long as the volume ratio is within the range of 1:1 to 200:1.

### Fiber Aggregate Forming Step

Next, the composite fiber aggregate 18 subjected to the first heat treatment is placed on the collector 13 in the electrospinning apparatus illustrated in FIG. 2. Then the second resin solution supplying device 10 and the second voltage applying device 15 are operated to jet out the second resin solution 8 from the second nozzle 9 toward the collector 13. As a result, as illustrated in FIG. 3C, a multilayer body 20 in which a fiber aggregate 19 composed solely of the second resin is formed on the composite fiber aggregate 18 subjected to the first heat treatment can be obtained.

### Second Heat Treatment Step

Next, the multilayer body 20 including the composite fiber aggregate 18 subjected to the first heat treatment and the fiber aggregate 19 composed of the second resin is subjected to a second heat treatment to form a porous body 23 having a first porous layer 21 and a second porous layer 22 illustrated in FIG. 3D.

The second heating temperature in the step of performing the second heat treatment is higher than or equal to the softening point of the second resin but lower than the softening point of the first resin. When the second heating temperature is lower than the softening point of the second resin, the fibers containing the second resin do not bond to one another and thus the mechanical strength is degraded. In addition, when the second heating temperature is equal to or higher than the softening point of the first resin, melting of the first resin and the second resin contained in the composite fiber aggregate subjected to the first heat treatment proceed excessively, and this may result in clogging of the pores and degradation of the liquid permeability. The difference between the second heating temperature and the softening point of the second resin is preferably 0° C. or more and 20° C. or less and more preferably 5° C. or more and 15° C. or less.

During the heat treatment, the multilayer body 20 may be additionally subjected to a pressurizing treatment. In other words, the second heat treatment may be a heating and pressurizing treatment. This is because heating and pressurizing the multilayer body 20 increase the contact area between the fibers, and the fibers readily bond to one another. However, excessive pressurizing reduces the gaps and degrades the liquid permeability; thus, the pressure is preferably 0.1 kg/cm² or more and 10 kg/cm² or less and more preferably 0.1 kg/cm² or more and 5 kg/cm² or less.

Examples of the heating device that can be used include a hot air drier, an oven, an infrared heating device, and a microwave heating device. When pressurizing is to be additionally performed, a flat pressing machine, a roll pressing machine, a laminating machine, or a calendering machine equipped with a heating mechanism can be used as appropriate, for example.

### Inkjet Recording Apparatus

An inkjet recording apparatus according to the present disclosure includes an image forming unit that forms a first image on an ejection-receiving medium, the first image containing a liquid component and a coloring material; and a liquid absorbing member including a porous body, and absorbing at least part of the liquid component from the first image by bringing the porous body into contact with the first image. The aforementioned porous body is used as this porous body.

The inkjet recording apparatus according to an embodiment of the present disclosure will now be described with reference to the drawings.

There are two types of the inkjet recording apparatus of this embodiment. One is an inkjet recording apparatus that forms an ink image by ejecting an ink onto a transfer body serving as an ejection-receiving medium (a transfer body or a record medium that directly receives the ejected ink), and transfers the ink image onto a record medium after the liquid is absorbed from the ink image by the liquid absorbing member. Another is an inkjet recording apparatus that forms an ink image on a record medium such as a sheet of paper or cloth serving as an ejection-receiving medium, and absorbs liquid from the ink image on the record medium by using a liquid absorbing member. In the present disclosure, the former inkjet recording apparatus is referred to as a “transfer-type inkjet recording apparatus” and the latter inkjet recording apparatus is referred to as a “direct drawing-type inkjet recording apparatus” hereinafter for the sake of convenience.

The transfer-type inkjet recording apparatus is described below as an example.

### Transfer-Type Inkjet Recording Apparatus

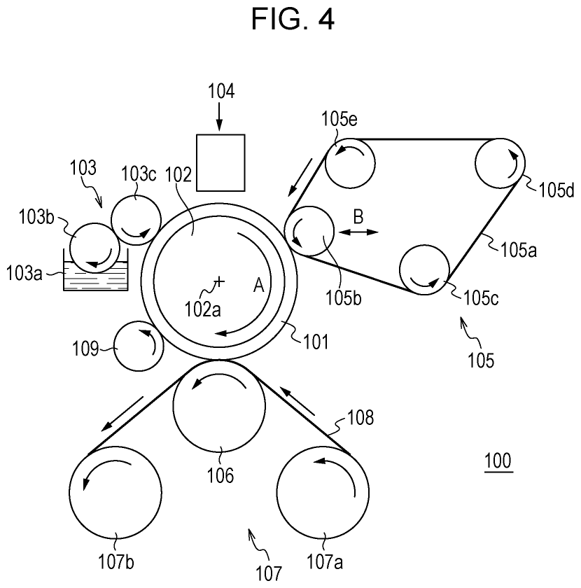

FIG. 4 is a schematic diagram illustrating one example of an overall structure of a transfer-type inkjet recording apparatus according to this embodiment.

A transfer-type inkjet recording apparatus 100 is equipped with a transfer body 101 that temporarily holds a first image and a second image obtained by absorbing and removing at least part of a first liquid from the first image. The transfer-type inkjet recording apparatus 100 is also equipped with a transferring pressing member 106 that transfers the second image onto a record medium, such as a sheet of paper, on which an image is to be formed, in other words, a record medium for forming an intended final image.

The transfer-type inkjet recording apparatus 100 has following members and devices.

A transfer body 101 supported by a supporting member 102. A reaction liquid applying device 103 that applies a reaction liquid to the transfer body 101. An ink applying device 104 that applies an ink to the transfer body 101 to which the reaction liquid is applied so as to form a first image on the transfer body. A liquid absorbing device 105 that absorbs a liquid component from the first image on the transfer body. A pressing member 106 that presses a record medium 108 to transfer a second image, from which the liquid component is removed, on the transfer body onto the record medium 108, such as a sheet of paper. The transfer-type inkjet recording apparatus 100 may also include a transfer body cleaning member 109 that cleans the surface of the transfer body 101 after the second image is transferred onto the record medium 108.

The supporting member 102 rotates in the arrow A direction in FIG. 4 about the rotation axis 102a as the center. As the supporting member 102 rotates, the transfer body 101 is moved. The moving transfer body 101 sequentially receives the reaction liquid from the reaction liquid applying device 103 and the ink from the ink applying device 104, and a first image is formed on the transfer body 101 as a result. The first image formed on the transfer body 101 is moved together with the transfer body 101 to a position where the first image contacts a liquid absorbing member 105a of the liquid absorbing device 105.

The liquid absorbing member 105a of the liquid absorbing device 105 moves in synchronization with the rotation of the transfer body 101. The first image formed on the transfer body 101 undergoes the state in which the first image contacts the moving liquid absorbing member 105a. During this time, the liquid absorbing member 105a removes at least part of the liquid component from the first image. The liquid component contained in the first image is removed as the first image undergoes the state in which the first image contacts the liquid absorbing member 105a. In the contact state, the liquid absorbing member 105a can be pressed against the first image at a particular pressing force in order for the liquid absorbing member 105a to function effectively.

To describe the removal of the liquid component from a different perspective, this process can be expressed as concentrating the ink constituting the first image formed on the transfer body. Concentrating the ink means that the ratio of the amount of solid components such as a coloring material and a resin contained in the ink relative to the amount of the liquid component in the ink is increased as a result of the decrease in the amount of the liquid component contained in the ink.

The second image, which is obtained by removing the liquid component from the first image, is moved to a transfer portion as the transfer body 101 moves, and, at that transfer portion, contacts the record medium 108, which is conveyed by a record medium conveying device 107. While the second image after the liquid component removal contacts the record medium 108, the pressing member 106 presses the record medium 108, and the image (ink image) is transferred onto the record medium as a result. The transferred ink image on the record medium 108 is a reverse image of the second image. In the description below, this transferred ink image may be referred to as the “third image” to distinguish it from the first image (ink image before liquid removal) and the second image (ink image after liquid removal) mentioned above.

Since a first image is formed on the transfer body by applying the ink after applying the reaction liquid, the reaction liquid in a non-image region (non-ink-image forming region) remains unreacted with the ink. In this apparatus, the liquid absorbing member 105a contacts not only the first image but also the unreacted reaction liquid so that the liquid component in the reaction liquid is removed from the reaction liquid as well as from the first image on the surface of the transfer body 101.

Thus, although the expression “the liquid component is removed from the first image” is used in the description above, this expression is not limited to the case in which the liquid component is removed only from the first image and is also used to mean that it suffices if the liquid component is removed from at least the first image on the transfer body. For example, it is possible to remove the liquid component in the reaction liquid applied to the outside region of the first image as well as the liquid component in the first image. The liquid component is not particularly limited as long as that component has no particular shape, has fluidity, and has a substantially constant volume. Examples of the liquid component include water and an organic solvent contained in the ink and the reaction liquid.

The ink can be concentrated by the liquid absorbing treatment even when a clear ink is contained in the first image. For example, when a clear ink is applied to a chromatic color ink containing a coloring material applied to the transfer body 101, the clear ink is present over the entire surface of the first image. Alternatively, the clear ink is present in one portion or two or more portions on the surface of the first image, and the chromatic color ink is present in other portions. In a portion of the first image where the clear ink is present over the chromatic color ink, the porous body absorbs the liquid component in the clear ink on the surface of the first image, and the liquid component in the clear ink thereby moves. As a result of this, the liquid component in the chromatic color ink moves toward the porous body, and thus the aqueous liquid component in the chromatic color ink is absorbed. Meanwhile, in a portion of the surface of the first image where a clear ink region and a chromatic color ink region are present, the liquid components in both the chromatic color ink and the clear ink move toward the porous body, and thus the aqueous liquid components are absorbed. The clear ink may contain a large amount of a component that improves transferability of the image from the transfer body 101 to the record medium. The clear ink for improving the transferability of the image is also referred to as a transfer assisting liquid. For example, the content of a component that exhibits an increased viscosity to the record medium when heated compared to the chromatic color ink may be increased.

The respective features of the transfer-type inkjet recording apparatus according to this embodiment will now be described.

### Reaction Liquid Applying Device

The inkjet recording apparatus of this embodiment includes a reaction liquid applying device 103 that applies a reaction liquid to the transfer body 101. FIG. 4 illustrates the case in which the reaction liquid applying device 103 is a gravure offset roller equipped with a reaction liquid storage 103a, and reaction liquid applying members 103b and 103c that apply the reaction liquid in the reaction liquid storage 103a to the transfer body 101.

The reaction liquid applying device may be any device that can apply a reaction liquid for increasing ink viscosity to an ejection-receiving medium, and any of various devices known in the art can be used as appropriate. Specific examples thereof include a gravure offset roller, an inkjet head, a die coating device (die coater), and a blade coating device (blade coater). Application of the reaction liquid by the reaction liquid applying device may be performed before or after application of the ink as long as the reaction liquid can be mixed (reacted) with the ink on the ejection-receiving medium. For example, the reaction liquid can be applied before application of the ink. By applying the reaction liquid before application of the ink, bleeding, which is mixing of applied adjacent inks during image recording by an inkjet system, and beading, which is attraction of a previously applied ink to a latterly applied ink, can be suppressed.

### Reaction Liquid

The reaction liquid contains a component that increases viscosity of the ink (ink viscosity increasing component). The reaction liquid increases the viscosity of the ink by coming into contact with the ink. Increasing the viscosity of the ink means that a coloring material, a resin, or the like, that constitutes part of the ink comes into contact with the ink viscosity increasing component and thereby is chemically reacted with or physically adsorbed to the component, resulting in an increase in the ink viscosity. The increase in ink viscosity not only refers to the case in which an increase in ink viscosity is observed but also the case in which the viscosity increases locally by coagulation of part of the components constituting the ink, for example, a coloring material and a resin. A reaction liquid that decreases the dispersion stability of the pigment in the aqueous ink can be used to coagulate part of the components constituting the ink. This ink viscosity increasing component has an effect of decreasing the fluidity of the ink and/or part of the components constituting the ink on the ejection-receiving medium so as to suppress bleeding or beading that occurs during formation of the first image. Increasing the viscosity of the ink is also referred to as “rendering the ink more viscous”. Examples of the ink viscosity increasing component that can be used include known components such as polyvalent metal ions, organic acids, cationic polymers, and porous particles. Among these, polyvalent metal ions and organic acid are suitable for the use. It is also recommendable to incorporate two or more types of ink viscosity increasing components. The ink viscosity increasing component content in the reaction liquid can be 5 mass % or more relative to the total mass of the reaction liquid.

Examples of the polyvalent metal ions include divalent metal ions such as Ca²⁺, Cu²⁺, Ni²⁺, Mg²⁺, Sr²⁺, Ba²⁺, and Zn²⁺ and trivalent metal ions such as Fe³⁺, Cr³⁺, Y³⁺, and Al³⁺.

Examples of the organic acids include oxalic acid, polyacrylic acid, formic acid, acetic acid, propionic acid, glycolic acid, malonic acid, malic acid, maleic acid, ascorbic acid, levulinic acid, succinic acid, glutaric acid, glutamic acid, fumaric acid, citric acid, tartaric acid, lactic acid, pyrrolidone carboxylic acid, pyrone carboxylic acid, pyrrole carboxylic acid, furan carboxylic acid, pyridine carboxylic acid, coumaric acid, thiophene carboxylic acid, nicotinic acid, oxysuccinic acid, and dioxysuccinic acid.

The reaction liquid can contain an appropriate amount of water or a low-volatility organic solvent as a first liquid. Water used in this case can be deionized water obtained by ion exchange or the like. The organic solvent that can be used in the reaction liquid is not particularly limited, and a known organic solvent can be used.

A surfactant and/or a viscosity adjustor can be added to the reaction liquid to appropriately adjust the surface tension and viscosity of the reaction liquid. The material that can be used therefor may be any material that can coexist with the ink viscosity increasing component. Specific examples of the surfactant include an acetylene glycol-ethylene oxide adduct (trade name: Acetylenol E100 produced by Kawaken Fine Chemicals Co., Ltd.) and a perfluoroalkyl-ethylene oxide adduct (tradename: MEGAFACE F444 produced by DIC Corporation).

### Ink Applying Device

The inkjet recording apparatus of this embodiment includes an ink applying device 104 that applies an ink to the transfer body 101 to which the reaction liquid has been applied. The first image is formed as the reaction liquid mixes with the ink, and then the liquid component is absorbed from the first image by the liquid absorbing device 105 provided next.

An inkjet head is used as the ink applying device that applies an ink. Examples of the type of the inkjet head include an inkjet head that ejects an ink by causing ink film boiling by using an electric-thermal converter to form bubbles, an inkjet head that ejects an ink by using an electric-mechanical converter, and an inkjet head that ejects an ink by utilizing static electricity. In the present disclosure, a known inkjet head can be used. In particular, from the viewpoint of high-speed, high-density printing, an inkjet head that uses an electric-thermal converter can be used. Drawing is performed by receiving an image signal and applying a needed amount of ink at each position.

Although the ink application amount can be expressed by image density (duty) or ink thickness, in this embodiment, the average value obtained by multiplying the mass of each ink dot by the number of dots applied (ejection number) and dividing the obtained product by a printing area is used as the ink application amount (g/m²).

The inkjet recording apparatus of the present disclosure may include two or more inkjet heads to apply inks of respective colors to the ejection-receiving medium. For example, when color images are to be formed by using a yellow ink, a magenta ink, a cyan ink, and a black ink, the inkjet recording apparatus has four inkjet heads that respectively eject the aforementioned four inks onto an ejection-receiving medium. The ink applying device may include an inkjet head that ejects an ink that does not contain a coloring material (clear ink).

### Ink

The components of the ink used in the present disclosure will now be described.

### Coloring Material

A pigment or a mixture of a dye and a pigment can be used as the coloring material contained in the ink used in the present disclosure. The type of the pigment that can be used as the coloring material may be any. Specific examples of the pigment include inorganic pigments such as carbon black; and organic pigments such as azo-based, phthalocyanine-based, quinacridone-based, isoindolinone-based, imidazolone-based, diketopyrrolopyrrole-based, and dioxazine-based pigments. These pigments can be used alone or in combination of two or more as needed.

The type of the dye that can be used as the coloring material may be any. Specific examples of the dye include direct dyes, acidic dyes, basic dyes, dispersion dyes, and food dyes, and a dye having an anionic group can be used. Specific examples of the dye skeletons include an azo skeleton, a triphenylmethane skeleton, a phthalocyanine skeleton, an azaphthalocyanine skeleton, a xanthene skeleton, and an anthrapyridone skeleton.

The pigment content in the ink relative to the total mass of the ink is preferably 0.5 mass % or more and 15.0 mass % or less and more preferably 1.0 mass % or more and 10.0 mass % or less.

### Dispersant

A known dispersant used in the inkjet ink can be used as the dispersant that disperses the pigment. In particular, in the embodiment of the present disclosure, a water-soluble dispersant that has both a hydrophilic moiety and a hydrophobic moiety in the structure can be used. Specifically, a pigment dispersant formed of a resin obtained by copolymerization of at least a hydrophilic monomer and a hydrophobic monomer can be used. The monomers used here are not particularly limited, and known monomers can be used. Examples of the hydrophobic monomer include styrene and styrene derivatives, alkyl (meth)acrylate, and benzyl (meth)acrylate. Examples of the hydrophilic monomer include acrylic acid, methacrylic acid, and maleic acid.

The acid value of the dispersant can be 50 mgKOH/g or more and 550 mgKOH/g or less. The weight-average molecular weight of the dispersant can be 1000 or more and 50000 or less. The mass ratio of the pigment to the dispersant (pigment:dispersant) can be in the range of 1:0.1 to 1:3.

Alternatively, a dispersant can be omitted, and a self-dispersible pigment obtained by surface-modifying the pigment so that the pigment itself becomes dispersible can be used.

### Resin Particles

The ink used in the present disclosure can contain various types of particles that do not contain a coloring material. In particular, resin particles can be used since the resin particles may have an effect of improving image quality and fixability.

The material for the resin particles that can be used in the present disclosure is not particularly limited, and a known resin can be used as appropriate. Specific examples thereof include homopolymers such as polyolefin, polystyrene, polyurethane, polyester, polyether, polyurea, polyamide, polyvinyl alcohol, poly(meth)acrylic acid and salts thereof, polyalkyl (meth)acrylate, and polydiene; and copolymers obtained by polymerizing two or more of monomers used to synthesize these homopolymers. The weight-average molecular weight (Mw) of the resin can be in the range of 1,000 or more and 2,000,000 or less. The resin particle content in the ink relative to the total mass of the ink is preferably 1 mass % or more and 50 mass % or less and more preferably 2 mass % or more and 40 mass % or less.

In an embodiment of the present disclosure, a resin particle dispersion in which the resin particles are dispersed in a liquid can be used. The dispersing technique is not particularly limited; however, a self-dispersion resin particle dispersion dispersed by using a resin obtained by homopolymerization of a monomer having a dissociative group or copolymerization of two or more monomers having a dissociative group can be used. Examples of the dissociative group include a carboxyl group, a sulfonic acid group, and a phosphoric acid group, and examples of the monomer having a dissociative group include acrylic acid and methacrylic acid. An emulsion dispersion-type resin particle dispersion obtained by dispersing resin particles with an emulsifier can also be used in the present disclosure. Here, the emulsifier can be a known surfactant regardless of the molecular weight. The surfactant can be a nonionic surfactant or a surfactant having charges of the same polarity as that of the resin particles.

The resin particle dispersion used in an embodiment of the present disclosure preferably has a dispersed particle diameter of 10 nm or more and 1000 nm or less, more preferably 50 nm or more and 500 nm or less, and yet more preferably 100 nm or more and 500 nm or less.

When preparing the resin particle dispersion used in an embodiment of the present disclosure, various additives can be added to stabilize the dispersion. Examples of the additives include n-hexadecane, dodecyl methacrylate, stearyl methacrylate, chlorobenzene, dodecyl mercaptan, blue dye (blueing agent), and polymethyl methacrylate.

### Surfactant

The ink that can be used in the present disclosure may contain a surfactant. A specific example of the surfactant is an acetylene glycol-ethylene oxide adduct (trade name: Acetylenol E100 produced by Kawaken Fine Chemicals Co., Ltd.). The amount of the surfactant in the ink relative to the total mass of the ink can be 0.01 mass % or more and 5.0 mass % or less.

### Water and Water-Soluble Organic Solvent

The ink used in the present disclosure can contain, as a solvent, water and/or a water-soluble organic solvent. Water can be deionized water obtained by ion exchange or the like. The water content in the ink relative to the total mass of the ink is preferably 30 mass % or more and 97 mass % or less and more preferably 50 mass % or more and 95 mass % or less.

The type of the water-soluble organic solvent is not particularly limited, and any known organic solvent can be used. Specific examples thereof include glycerin, diethylene glycol, polyethylene glycol, polypropylene glycol, ethylene glycol, propylene glycol, butylene glycol, triethylene glycol, thiodiglycol, hexylene glycol, ethylene glycol monomethyl ether, diethylene glycol monomethyl ether, 2-pyrrolidone, ethanol, and methanol. Naturally, two or more selected from these solvents may be used as a mixture.

The water-soluble organic solvent content in the ink relative to the total mass of the ink can be 3 mass % or more and 70 mass % or less.

### Other Additives

The ink that can be used in the present disclosure can contain, in addition to the components described above, various additives, such as a pH adjustor, an antirust agent, a preservative, an antifungal agent, an antioxidant, a reducing inhibitor, a water-soluble resin and a neutralizing agent therefor, and a viscosity adjustor, as needed.

### Liquid Absorbing Device

In this embodiment, the liquid absorbing device 105 includes a liquid absorbing member 105a, and a pressing member 105b that is provided for liquid absorption and that presses the liquid absorbing member 105a against the first image on the transfer body 101. When the pressing member 105b is actuated and presses a second surface of the liquid absorbing member 105a, the first image passes through a nip portion formed when a first surface of the porous body is allowed to contact the outer peripheral surface of the transfer body 101; as a result, the liquid can be absorbed from the first image. Here, the region where the liquid absorbing member 105a presses and contacts the outer peripheral surface of the transfer body 101 is defined as a liquid absorbing region.

The position of the pressing member 105b relative to the transfer body 101 can be adjusted by a position controlling mechanism (not illustrated). For example, the pressing member 105b is configured to make reciprocal movement in the arrow B direction in FIG. 4 so that the pressing member 105b can cause the liquid absorbing member 105a to contact the outer peripheral surface of the transfer body 101 at the timing when the liquid absorbing treatment is necessary, and can cause the liquid absorbing member 105a to move away from the outer peripheral surface.

The liquid absorbing member 105a and the pressing member 105b may have any shape. For example, as illustrated in FIG. 4, the pressing member 105b may have a columnar shape, the liquid absorbing member 105a may have a belt shape, and the columnar-shaped pressing member 105b may press the belt-shaped liquid absorbing member 105a against the transfer body 101. Alternatively, the pressing member 105b may have a columnar shape, the liquid absorbing member 105a may have a cylindrical shape formed on the circumferential surface of the columnar-shaped pressing member 105b, and the columnar-shaped pressing member 105b may press the cylindrical-shaped liquid absorbing member 105a against the transfer body.

In the present disclosure, considering the space inside the inkjet recording apparatus, etc., the liquid absorbing member 105a can have a belt shape. The liquid absorbing device 105 that includes the belt-shaped liquid absorbing member 105a may also include a extending member that keeps the liquid absorbing member 105a taut. In FIG. 4, extending rollers 105c, 105d, and 105e are used as the extending member. These extending rollers and the belt-shaped liquid absorbing member 105a stretched across the extending rollers constitute a liquid absorbing member conveying device that conveys the liquid absorbing member that absorbs liquid from the first image. The liquid absorbing member can be brought in and out of the liquid absorbing region and can be re-fed by this conveying device. In FIG. 4, the pressing member 105b is configured as a roller member that rotates as with the extending rollers, but is not limited to this configuration.

When the extending rollers abut against a surface of the liquid absorbing member 105a that contacts the first image, the material for the extending rollers can be a slidable material or a soft material, and a fluororesin or the like can be used as the material. The extending roller that abuts against the surface that contacts the first image can be formed of a material different from the material of the surface of a extending roller that abuts against the opposite surface.

In the liquid absorbing device 105, the pressing member 105b that has a porous body presses the liquid absorbing member 105a against the first image so that at least part of the liquid component contained in the first image is absorbed by the liquid absorbing member 105a, thereby forming a second image, the liquid component of which is reduced from the first image. Examples of the method for reducing the liquid component in the first image include the aforementioned method of pressing a liquid absorbing member, and various known techniques, such as a method that uses heat, a method that sends low-humidity air, and a method that involves depressurizing, that can be employed in combination. Alternatively, these methods can be performed on the second image containing a decreased amount of liquid component so that the liquid component is further decreased.

Various conditions and structures in the liquid absorbing device 105 will now be described in detail.

### Liquid Absorbing Member

In the present disclosure, at least part of the liquid component is absorbed from the first image by causing the first image to contact a liquid absorbing member equipped with a porous body so that the liquid component content in the first image is decreased. A surface of the liquid absorbing member that contacts the first image is defined as the first surface, and a porous body having a first porous layer 21 and a second porous layer 22 is placed in such a manner that the second porous layer 22 serves constitutes the first surface. In the present disclosure, the porous body may have three or more layers, and the number of layers is not limited.

A liquid absorbing member that has such a porous body can have a shape that enables liquid absorption in a circulating manner, such that the liquid absorbing member moves in conjunction with the movement of the ejection-receiving medium, abuts against the first image, and then again abuts against another first image at a particular period. For example, the liquid absorbing member can have an endless belt shape or a drum shape.

### Pretreatment

In the present disclosure, before the liquid absorbing member is allowed to contact the first image, a pretreatment liquid applying device that has a pretreatment liquid applying unit can be provided as needed. The treatment liquid used for the pretreatment contains water and a water-soluble organic solvent. Water can be deionized water obtained by ion exchange or the like. The type of the water-soluble organic solvent is not particularly limited, and a known organic solvent such as ethanol or isopropyl alcohol can be used. In the pretreatment of the liquid absorbing member used in the present disclosure, the application method is not particularly limited and can involve immersing or droplet dropping.

The presumption of the present disclosure is that the same liquid absorbing member repeatedly makes contacts with images. The liquid absorbing member contacts the images while holding the liquid inside.

### Pressurizing Conditions

The pressure at which the first image is pressed can be 0.3 kgf/cm² or more since the liquid in the first image can undergo solid-liquid separation and the liquid can be absorbed in a short time. For the purposes of this description, the “pressure” means the nip pressure between the record medium and the absorbent, and is determined by measuring the surface pressure with a surface pressure distribution analyzer (I-SCAN produced by NITTA Corporation) and dividing the load in the pressurizing region by the area.

### Application Time

The length of time the pressure acts on the first image (application time) can be within 50 ms since the liquid in the first image can be absorbed. The application time is more preferably 10 to 20 ms since adhesion of the coloring material in the first image is suppressed.

The application time is calculated by dividing the pressure-sensing width of the record medium in the conveying direction in the surface pressure measurement described above by the moving speed of the record medium.

In the present disclosure, a porous film prepared as described above can be used as the absorbent, and the absorbent can be formed of a fluororesin.

At least one supporting layer, which is another porous body for supporting and reinforcing the aforementioned porous body, can be provided on a surface of the porous film that does not contact a printed article. The supporting layer can be a porous body formed of a polyolefin (polyethylene (PE), polypropylene (PP), or the like), polyurethane, nylon, polyamide, polyester (polyethylene terephthalate (PET) or the like), or polysulfone (PSF). One example of a method for preparing such a supporting layer involves forming a fleece by a dry method, a wet method, a spunbonding method, an electrospinning method, or the like, and then bonding between the fibers by a chemical bonding method, a thermal bonding method, a needle punching method, a hydro entanglement method, or the like.

### Transfer Body

The transfer body 101 has a surface layer that includes an image forming surface. Various materials, such as resins and ceramics, can be used as appropriate as the member of the surface layer, but a material having a high compressive elastic modulus can be used from the viewpoint of durability. Specific examples thereof include acrylic resins, acryl silicone resins, fluorine-containing resins, and condensation products obtained by condensation of hydrolytic organic silicon compounds. The surface treatment may be performed to improve the wettability to the reaction liquid, transferability, etc. Examples of the surface treatment include a flame treatment, a corona treatment, a plasma treatment, a polishing treatment, a roughening treatment, an active energy ray irradiation treatment, an ozone treatment, a surfactant treatment, and a silane coupling treatment. Two or more of these treatments may be combined. The surface layer can be processed to have any desired surface profile.

The transfer body can have a compression layer having a function of absorbing the pressure fluctuations. The compression layer absorbs deformation and disperses the local pressure fluctuations so that satisfactory transferability can be maintained even during high-speed printing. Examples of the member for the compression layer include acrylonitrile-butadiene rubber, chloroprene rubber, urethane rubber, and silicone rubber. When forming the rubber material mentioned above, particular amounts of a vulcanizing agent and a vulcanization accelerator can be blended, and, additionally, a blowing agent and a filler, such as hollow particles or common salt, can be further blended as needed to make the layer porous. As a result, the foamed portion becomes compressed while undergoing a volume change against various pressure fluctuations, and thus deformation in directions other than the compression direction is small, and more stable transferability and durability can be obtained. A porous rubber material having an open pore structure in which pores are continuous to one another and a porous rubber material having a closed pore structure in which each pore is independent are available as the porous rubber material. Either structure may be employed in the present disclosure, or both of these structures may be used in combination.

The transfer body can have an elastic layer between the surface layer and the compression layer. Various materials, such as resins and ceramics, can be used as appropriate as the member of the elastic layer. From the viewpoint of processing properties etc., various elastomer materials and rubber materials can be used. Specific examples thereof include fluorosilicone rubber, phenyl silicone rubber, fluororubber, chloroprene rubber, urethane rubber, nitrile rubber, ethylene propylene rubber, natural rubber, styrene rubber, isoprene rubber, butadiene rubber, ethylene/propylene/butadiene copolymers, and nitrile butadiene rubber. In particular, silicone rubber, fluorosilicone rubber, and phenyl silicone rubber have small compression set and are thus favorable from the viewpoints of dimension stability and durability. These materials are favorable from the viewpoint of transferability also since the change in elastic modulus relative to temperature is small.

Various types of adhesives and double-stick tapes can be interposed between the respective layers (surface layer, elastic layer, and compression layer) constituting the transfer body to fix and hold these layers. In order to suppress horizontal elongation that occurs when the transfer body is being installed in an apparatus or in order to keep strength, a reinforcing layer having a high compressive elastic modulus may be provided. In addition, a woven fabric may be used as a reinforcing layer. The transfer body can be prepared by combining respective layers of the aforementioned materials as desired.

The size of the transfer body can be freely selected according to the intended printed image size. The shape of the transfer body is not particularly limited, and examples of the shape include a sheet shape, a roller shaper, a belt shape, and an endless web shape.

### Supporting Member

The transfer body 101 is supported on the supporting member 102. Various adhesives and double-stick tapes can be used to support the transfer body. Alternatively, an installation member formed of a ceramic, a resin, or the like may be attached to the transfer body, and the transfer body may be supported on the supporting member 102 by using the installation member.

From the viewpoints of conveyance accuracy and durability, the supporting member 102 is required to have some degree of structural strength. The material of the supporting member can be a metal, a ceramic, a resin, or the like. In particular, in order to improve the control responsiveness by reducing inertia during operation in addition to obtaining dimension accuracy and stiffness that withstands pressure during transferring, aluminum, iron, stainless steel, acetal resins, epoxy resins, polyimide, polyethylene, polyethylene terephthalate, nylon, polyurethane, silica ceramics, and alumina ceramics can be used. These can be used in combination.

### Pressing Member for Transfer

In this embodiment, while the second image makes contact with the record medium 108 conveyed by the record medium conveying device 107, the pressing member 106 for transfer presses the record medium 108 so as to transfer the image (ink image) onto the record medium 108. After the liquid component contained in the first image on the transfer body 101 is removed, the first image is transferred onto the record medium 108. In this manner, a recorded image (third image) in which curling, cockling, etc., are suppressed can be obtained.

From the viewpoints of accuracy of conveying the record medium 108 and durability, the pressing member 106 is required to have some degree of structural strength. The material of the pressing member 106 can be a metal, a ceramic, a resin, or the like. In particular, in order to improve the control responsiveness by reducing inertia during operation in addition to obtaining dimension accuracy and stiffness that withstands pressure during transferring, aluminum, iron, stainless steel, acetal resins, epoxy resins, polyimide, polyethylene, polyethylene terephthalate, nylon, polyurethane, silica ceramics, and alumina ceramics can be used. These can be used in combination. The shape of the pressing member 106 is not particularly limited. For example, the pressing member 106 may have a roller shape.

The length of time the pressing member 106 presses the record medium 108 in order to transfer the second image on the transfer body 101 onto the record medium 108 is not particularly limited. For example, in order to carry out transfer satisfactorily without impairing the durability of the transfer body, the length of time can be 5 ms or longer and 100 ms or shorter. For the purposes of this description, the length of time of pressing in this embodiment refers to the length of time the record medium 108 contacts the transfer body 101, and is calculated by measuring the surface pressure with a surface pressure distribution analyzer and dividing the length of the pressurizing region in the conveying direction by the conveying speed. A surface pressure distribution analyzer known in the trade as I-SCAN, produced by NITTA Corporation, can be used as the surface pressure distribution analyzer.

The pressure at which the pressing member 106 presses the record medium 108 in order to transfer the second image on the transfer body 101 onto the record medium 108 is not particularly limited as long as transfer is carried out satisfactorily and the durability of the transfer body is not impaired. Thus, the pressure can be 9.8 N/cm² (1 kgf/cm²) or more and 294.2 N/cm² (30 kgf/cm²) or less. The pressure in this embodiment refers to a nip pressure between the record medium 108 and the transfer body 101, and is calculated by measuring the surface pressure with a surface pressure distribution analyzer and dividing the load in the pressurizing region by the area.

The temperature at which the pressing member 106 presses the record medium 108 in order to transfer the second image on the transfer body 101 onto the record medium 108 is not particularly limited, but the temperature can be higher than or equal to the glass transition point or softening point of the resin component contained in the ink. A heating device that heats the second image on the transfer body 101, the transfer body 101, and the record medium 108 can be provided to perform heating.

### Record Medium and Record Medium Conveying Device

The record medium 108 in this embodiment is not particularly limited, and any known record medium can be used. Examples of the record medium include a long record medium wound into a roll, or sheets cut to predetermined dimensions. Examples of the material include paper, plastic films, wood plates, cardboards, and metal films.

In FIG. 4, the record medium conveying device 107 for conveying the record medium 108 is constituted by a record medium pickup roller 107a and a record medium winding roller 107b; however, the structure is not limited to this as long as the record medium can be conveyed.

The present disclosure can provide a method for producing a porous body having high liquid permeability and high mechanical strength even when the porous body to be produced is a multilayer body having two or more porous layers. In addition, the present disclosure can provide a porous body obtained by the aforementioned method for producing the porous body, and an inkjet recording apparatus that includes the porous body.

### EXAMPLES

The present disclosure will now be described in further detail through Examples and Comparative Examples below. The present invention is not limited by these examples as long as the examples are within the gist of the present disclosure. In the description of the examples below, “parts” is on a mass basis unless otherwise noted.

### Example 1

### Preparation of Porous Body

A porous body was prepared by using an electrospinning apparatus illustrated in FIG. 2.

First, a composite fiber aggregate 17 illustrated in FIG. 3A was formed as below.

A dimethylacetamide (specific gravity: 0.94)/tetrahydrofuran (specific gravity: 0.89) (mass ratio: 6/4) solution containing 27.5 mass % of polysulfone (product name: Udel PSU 1700NT produced by Solvay, specific gravity: 1.24) was prepared as the first resin solution 5, and placed in the first resin solution supplying device 7. The specific gravity of the first resin solution calculated from formula (2) was 1.01. A stainless steel nozzle having an inner diameter of 0.51 mm was used as the first nozzle 6. A dimethylacetamide (specific gravity: 0.94)/methyl isobutyl ketone (specific gravity: 0.80) (mass ratio: 5/5) solution containing 20 mass % of PTFE-HFP-VDF (product name: Dyneon THV221GZ produced by 3M, specific gravity: 1.95) and 0.01 mass % of lithium chloride was prepared as the second resin solution 8, and placed in the second resin solution supplying device 10. The specific gravity of the second resin solution calculated from formula (2) was 1.09. A stainless steel nozzle having an inner diameter of 0.22 mm was used as the second nozzle 9. An aluminum collector was used as the collector 13, and the distance between the first nozzle 6 and the collector 13 and the distance between the second nozzle 9 and the collector 13 were both set to 30 cm.

Next, 45 kV voltage was applied by the first voltage applying device 14 and the second voltage applying device 15 to start spinning, and a composite fiber aggregate 17 was thereby formed on the collector 13. During this process, the supplying amount from the first resin solution supplying device 7 was set to 2.5 ml/h and the supplying amount from the second resin solution supplying device 10 was set to 0.5 ml/h. The volume ratio of the first resin to the second resin calculated from formula (1) was 10:1.

The composite fiber aggregate 17 was peeled away from the collector 13, and a composite fiber aggregate 17 having first fibers and second fibers was obtained.

Next, the obtained composite fiber aggregate 17 was subjected to a first heat treatment to form a composite fiber aggregate 18 subjected to the first heat treatment illustrated in FIG. 3B. In the first heat treatment, the composite fiber aggregate 17 was heated and pressurized at a heating temperature of 160° C. and a pressure of 3 kg/cm² for 1 minute by using LABO PRESS T15 (produced Toyo Seiki Seisaku-sho, Ltd.). The thickness of the composite fiber aggregate 18 subjected to the first heat treatment was 30 μm.

Next, a fiber aggregate 19 having a second resin was formed as follows on the composite fiber aggregate 18 subjected to the first heat treatment so as to obtain a multilayer body 20 illustrated in FIG. 3C.

First, the composite fiber aggregate subjected to the first heat treatment was placed on a surface of the collector 13 in the electrospinning apparatus illustrated in FIG. 2. Next, a dimethylacetamide/methyl isobutyl ketone (mass ratio: 5/5) solution containing 20 mass % of PTFE-HFP-VDF (product name: Dyneon THV221GZ produced by 3M) and 0.01 mass % of lithium chloride was prepared as the second resin solution 8, and placed in the second resin solution supplying device 10. A stainless steel nozzle having an inner diameter of 0.22 mm was used as the second nozzle 9. The distance between the second nozzle 9 and the collector 13 was set to 30 cm.

Next, 45 kV voltage was applied by the second voltage applying device 15 to start spinning, and a fiber aggregate 19 having the second resin is formed on the composite fiber aggregate subjected to the first heat treatment disposed on the collector 13. As a result, a multilayer body 20 was obtained. During this process, the supplying amount from the second resin solution supplying device 10 was set to 0.5 ml/h.

The multilayer body 20 was peeled away from the collector 13 so as to obtain a multilayer body 20 that has a composite fiber aggregate 18 subjected to the first heat treatment and a fiber aggregate 19 that has the second resin.

Next, the obtained multilayer body 20 was subjected to the second heat treatment so as to form a porous body 23 having a first porous layer 21 and a second porous layer 22 illustrated in FIG. 3D. In the second heat treatment, the multilayer body 20 was heated and pressurized at a heating temperature of 60° C. and a pressure of 3 kg/cm² for 1 minute by using LABO PRESS T15 (produced Toyo Seiki Seisaku-sho, Ltd.). The thickness of the first porous layer 21 was 30 μm, and the thickness of the porous body 23 having the first porous layer 21 and the second porous layer 22 was 40 μm.

### Example 2

Next, an N,N-dimethylformamide (specific gravity: 0.94) solution containing 18 mass % of PVDF-HFP (product name: Solef 21510 produced by Solvay, specific gravity: 1.78) and 0.05 mass % of lithium chloride was prepared as the second resin solution 8, and placed in the second resin solution supplying device 10. The specific gravity of the second resin solution calculated from formula (2) was 1.09. In the second heat treatment, heating and pressurizing were performed at a heating temperature of 90° C. and a pressure of 3 kg/cm² for 1 minute. A porous body 23 having a first porous layer 21 and a second porous layer 22 was formed as in Example 1 except for the above-described conditions. The volume ratio of the first resin to the second resin calculated from formula (1) was 10:1.

### Example 3

A porous body 23 having a first porous layer 21 and a second porous layer 22 was formed as in Example 1 except that, in the step of forming the composite fiber aggregate 17, the supplying amount from the second resin solution supplying device 10 was changed to 5.0 ml/h. The volume ratio of the first resin to the second resin calculated from formula (1) was 1:1.

### Example 4

A porous body 23 having a first porous layer 21 and a second porous layer 22 was formed as in Example 1 except that, in the step of forming the composite fiber aggregate 17, the supplying amount from the second resin solution supplying device 10 was changed to 2.5 ml/h. The volume ratio of the first resin to the second resin calculated from formula (1) was 2:1.

### Example 5

A porous body 23 having a first porous layer 21 and a second porous layer 22 was formed as in Example 1 except that, in the step of forming the composite fiber aggregate 17, the supplying amount from the second resin solution supplying device 10 was changed to 0.05 ml/h. The volume ratio of the first resin to the second resin calculated from formula (1) was 100:1.

### Example 6

A dimethylacetamide/methyl isobutyl ketone (mass ratio: 5/5) solution containing 17.2 mass % of PTFE-HFP-VDP (product name: Dyneon THV221GZ, produced by 3M, specific gravity: 1.95) and 0.01 mass % of lithium chloride was prepared as the second resin solution 8 in the step of forming the composite fiber aggregate 17. The specific gravity of the second resin solution calculated from formula (2) was 1.06. Furthermore, a porous body 23 having a first porous layer 21 and a second porous layer 22 was formed as in Example 1 except that the supplying amount from the second resin solution supplying device 10 was changed to 0.03 ml/h. The volume ratio of the first resin to the second resin calculated from formula (1) was 200:1.

### Example 7

An N,N-dimethylformamide solution containing 20 mass % of polystyrene (weight-average molecular weight: 350,000, produced by Sigma-Aldrich, specific gravity: 1.04) and 0.05 mass % of lithium chloride was prepared as the second resin solution 8, and placed in the second resin solution supplying device 10. The specific gravity of the second resin solution calculated from formula (2) was 0.96. Furthermore, the supplying amount from the second resin solution supplying device 10 was changed to 0.03 ml/h. In addition, in the second heat treatment, heating and pressurizing were performed at a heating temperature of 110° C. and a pressure of 3 kg/cm² for 1 minute. A porous body 23 having a first porous layer 21 and a second porous layer 22 was formed as in Example 1 except for the above-described conditions. The volume ratio of the first resin to the second resin calculated from formula (1) was 10:1.

### Example 8

In the first heat treatment, heating was performed at a heating temperature of 160° C. for 60 minutes by using Clean Oven DES-82 (produced by Yamato Scientific Co., Ltd.). In the second heat treatment, heating was performed at a heating temperature of 60° C. for 60 minutes by using Clean Oven DES-82 (produced by Yamato Scientific Co., Ltd.). A porous body 23 having a first porous layer 21 and a second porous layer 22 was formed as in Example 1 except for the above-described conditions. The volume ratio of the first resin to the second resin calculated from formula (1) was 10:1.

### Example 9

An N,N-dimethylformamide solution containing 22 mass % of PVDF (product name: Kynar 721 produced by Arkema KK, specific gravity: 1.79) was prepared as the first resin solution 5, and placed in the first resin solution supplying device 7. The specific gravity of the first resin solution calculated from formula (2) was 1.13. Furthermore, an N,N-dimethylformamide solution containing 16 mass % of polyacrylonitrile (weight-average molecular weight: 150,000, produced by Sigma-Aldrich, specific gravity: 1.18) and 0.05 mass % of lithium chloride was prepared as the second resin solution 8 and placed in the second resin solution supplying device 10. The specific gravity of the second resin solution calculated from formula (2) was 0.98. The supplying amount from the first resin solution supplying device 7 was set to 2.9 ml/h, and the supplying amount from the second resin solution supplying device 10 was set to 0.3 ml/h. In the first heat treatment, heating and pressurizing were performed at a heating temperature of 145° C. and a pressure of 3 kg/cm² for 1 minute. In the second heat treatment, heating and pressurizing were performed at a heating temperature of 131° C. and a pressure of 3 kg/cm² for 1 minute. A porous body 23 having a first porous layer 21 and a second porous layer 22 was formed as in Example 1 except for the above-described conditions. The volume ratio of the first resin to the second resin calculated from formula (1) was 10:1.

### Example 10

An N,N-dimethylformamide solution containing 22 mass % of PVDF (product name: Kynar 721 produced by Arkema KK, specific gravity: 1.79) was prepared as the first resin solution 5, and placed in the first resin solution supplying device 7. The specific gravity of the first resin solution calculated from formula (2) was 1.13. The supplying amount from the first resin solution supplying device 7 was set to 2.4 ml/h, and the supplying amount from the second resin solution supplying device 10 was set to 0.3 ml/h. In the first heat treatment, heating and pressurizing were performed at a heating temperature of 145° C. and a pressure of 3 kg/cm² for 1 minute. A porous body 23 having a first porous layer 21 and a second porous layer 22 was formed as in Example 1 except for the above-described conditions. The volume ratio of the first resin to the second resin calculated from formula (1) was 10:1.

### Comparative Example 1

A porous body 23 having a first porous layer 21 and a second porous layer 22 was formed as in Example 1 except that the first heat treatment was omitted.

### Comparative Example 2

A porous body 23 having a first porous layer 21 and a second porous layer 22 was formed as in Example 1 except that the first heat treatment was omitted and, in the second heat treatment, heating and pressurizing were performed at a heating temperature of 160° C. and a pressure of 3 kg/cm² for 1 minute.

### Comparative Example 3

A porous body having a first porous layer and a second porous layer was formed as in Example 1 except that, in the first heat treatment, heating and pressurizing were performed at a heating temperature of 60° C. and a pressure of 3 kg/cm² for 1 minute.

### Comparative Example 4

A porous body 23 having a first porous layer 21 and a second porous layer 22 was formed as in Example 1 except that, in the second heat treatment, heating and pressurizing were performed at a heating temperature of 160° C. and a pressure of 3 kg/cm² for 1 minute.

### Comparative Example 5

A porous body 23 having a first porous layer 21 and a second porous layer 22 was formed as in Example 1 except that, in the step of forming the composite fiber aggregate 17, the supplying amount from the second resin solution supplying device 10 was changed to 6.0 ml/h. The volume ratio of the first resin to the second resin calculated from formula (1) was 0.8:1.

### Comparative Example 6

A porous body 23 having a first porous layer 21 and a second porous layer 22 was formed as in Example 1 except that, in the step of forming the composite fiber aggregate 17, the supplying amount from the second resin solution supplying device 10 was changed to 0.02 ml/h. The volume ratio of the first resin to the second resin calculated from formula (1) was 250:1.

Table 1 indicates the softening points, mechanical strengths, and tensile moduli of the resins used in Examples 1 to 10 and Comparative Examples 1 to 6. As for the softening point and the mechanical strength, a fiber aggregate prepared from a single resin was used for evaluation. The preparation of the fiber aggregates was carried out as with the preparation of the fiber aggregate 19 having the second resin in Example 1.

The softening point was measured with a thermomechanical analyzer Exstar 6000 (produced by Seiko Instruments Inc.). With a penetration probe having a diameter of 1 mm, the softening point was measured at a load of 30 mN and a temperature of 25 to 250° C. at a temperature elevation rate of 5° C./minute. A value obtained by extrapolated point calculation from the obtained result was used as the softening point. The mechanical strength was evaluated by using a tensile stress value in the thickness direction of the fiber aggregate. The tensile stress in the thickness direction of the fiber aggregate was measured with a fixability simulator FSR-1000 (produced by Rhesca Corporation). Specifically, a fiber aggregate was bonded to a probe side of the fixability simulator by using a double-stick tape (double-side tape NICE TACK 20MMX10M NW20 produced by Nichiban Co., Ltd.) and only a double-stick tape was bonded to the stage side of the fixability simulator. The probe was descended at 1 mm/second and pressed against the stage-side double-stick tape for 1 second, and then the adhesion strength measured during the process of withdrawing the probe at 10 mm/second was determined to be the tensile stress in the thickness direction. Furthermore, the tensile modulus was measured with a table-top precision universal tester AGS-10KNX (produced by Shimadzu Corporation) in accordance with JIS K 7161.

TABLE 1

| | Softening | | |
|---|---|---|---|
| | point | Mechanical strength | Elastic modulus |
| Resin | (° C.) | (kg/cm²) | (MPa) |
| Dyneon THV221GZ | 50 | 10.0 | 80 |
| Udel PSU1700NT | 150 | 17.5 | 2500 |
| Solef 21510 | 80 | 8.7 | 400 |
| Polystyrene | 100 | 11.2 | 3500 |
| (molecular weight: | | | |
| 350,000) | | | |
| Kynar 721 | 135 | 9.5 | 1300 |
| Polyacrylonitrile | 130 | 10.7 | 2700 |
| (molecular weight: | | | |
| 150,000) | | | |

Table 2 indicates the types of the first and second resins used for preparing the porous bodies in Examples 1 to 10 and Comparative Examples 1 to 6, the volume ratios of the first resin to the second resin, and the conditions of the first heat treatment and the second heat treatment. In Table 2, PS indicates polystyrene having a weight-average molecular weight of 350,000, and PAN indicates polyacrylonitrile having a weight-average molecular weight of 150,000.

TABLE 2

| | | | Volume | | | | | | |
|---|---|---|---|---|---|---|---|---|---|
| | | | ratio of | First heat treatment | | | Second heat treatment | | |
| | | | first resin | Heating | | | Heating | | |
| | | Second | to second | temperature | Pressure | Time | temperature | Pressure | Time |
| | First resin | resin | resin | (° C.) | (kg/cm²) | (minutes) | (° C.) | (kg/cm²) | (minutes) |
| Example 1 | Udel PSU | Dyneon | 10:1 | 160 | 3 | 1 | 60 | 3 | 1 |
| | 1700NT | THV | | | | | | | |
| | | 221GZ | | | | | | | |
| Example 2 | Udel PSU | Solef | 10:1 | 160 | 3 | 1 | 90 | 3 | 1 |
| | 1700NT | 21510 | | | | | | | |
| Example 3 | Udel PSU | Dyneon | 1:1 | 160 | 3 | 1 | 60 | 3 | 1 |
| | 1700NT | THV | | | | | | | |
| | | 221GZ | | | | | | | |
| Example 4 | Udel PSU | Dyneon | 2:1 | 160 | 3 | 1 | 60 | 3 | 1 |
| | 1700NT | THV | | | | | | | |
| | | 221GZ | | | | | | | |
| Example 5 | Udel PSU | Dyneon | 100:1 | 160 | 3 | 1 | 60 | 3 | 1 |
| | 1700NT | THV | | | | | | | |
| | | 221GZ | | | | | | | |
| Example 6 | Udel PSU | Dyneon | 200:1 | 160 | 3 | 1 | 60 | 3 | 1 |
| | 1700NT | THV | | | | | | | |
| | | 221GZ | | | | | | | |
| Example 7 | Udel PSU | PS | 10:1 | 160 | 3 | 1 | 110 | 3 | 1 |
| | 1700NT | | | | | | | | |
| Example 8 | Udel PSU | Dyneon | 10:1 | 160 | — | 60 | 60 | — | 60 |
| | 1700NT | THV | | | | | | | |
| | | 221GZ | | | | | | | |
| Example 9 | Kynar | PAN | 10:1 | 145 | 3 | 1 | 131 | 3 | 1 |
| | 721 | | | | | | | | |
| Example 10 | Kynar | Dyneon | 10:1 | 145 | 3 | 1 | 60 | 3 | 1 |
| | 721 | THV | | | | | | | |
| | | 221GZ | | | | | | | |
| Comparative | Udel PSU | Dyneon | 10:1 | — | | | 60 | 3 | 1 |
| Example 1 | 1700NT | THV | | | | | | | |
| | | 221GZ | | | | | | | |
| Comparative | Udel PSU | Dyneon | 10:1 | — | | | 160 | 3 | 1 |
| Example 2 | 1700NT | THV | | | | | | | |
| | | 221GZ | | | | | | | |
| Comparative | Udel PSU | Dyneon | 10:1 | 60 | 3 | 1 | 60 | 3 | 1 |
| Example 3 | 1700NT | THV | | | | | | | |
| | | 221GZ | | | | | | | |
| Comparative | Udel PSU | Dyneon | 10:1 | 160 | 3 | 1 | 160 | 3 | 1 |
| Example 4 | 1700NT | THV | | | | | | | |
| | | 221GZ | | | | | | | |
| Comparative | Udel PSU | Dyneon | 0.8:1 | 160 | 3 | 1 | 60 | 3 | 1 |
| Example 5 | 1700NT | THV | | | | | | | |
| | | 221GZ | | | | | | | |
| Comparative | Udel PSU | Dyneon | 250:1 | 160 | 3 | 1 | 60 | 3 | 1 |
| Example 6 | 1700NT | THV | | | | | | | |
| | | 221GZ | | | | | | | |

Next, the porous bodies obtained as described above were evaluated by the following evaluation methods. The evaluation results are indicated in Table 3. In the present disclosure, A and B of the evaluation standard for each evaluation item described below represent acceptable levels, and C represents an unacceptable level.

### Mechanical Strength

The mechanical strength was evaluated by using a tensile stress value in the thickness direction of the porous body. The tensile stress in the thickness direction of the porous body was measured with a fixability simulator FSR-1000 (produced by Rhesca Corporation). Specifically, a porous body prepared as above was bonded to a probe-side of the fixability simulator by using a double-stick tape (double-side tape NICE TACK 20MMX10M NW20 produced by Nichiban Co., Ltd.) and only a double-stick tape was bonded to the stage side of the porous body. The probe was descended at 1 mm/second and pressed against the stage-side double-stick tape for 1 second, and then the tack strength measured during the process of withdrawing the probe at 10 mm/second was determined to be the tensile stress in the thickness direction. The measurement results were evaluated according to the following evaluation standard.

A: The tensile stress was 8.0 kg/cm² or more.
B: The tensile stress was 5.0 kg/cm² or more but less than 8.0 kg/cm².
C: The tensile stress was less than 5.0 kg/cm².

### Liquid Permeability

The liquid permeability of the porous body was evaluated by a Gurley value of the porous body and by evaluation of an image formed by an inkjet recording apparatus equipped with the porous body.

First, the Gurley value of the porous body obtained as above was measured with a Gurley tester according to JIS P 8117. The measurement results were evaluated according to the following evaluation standard.

A: The Gurley value was less than 5 seconds.
B: The Gurley value was 5 seconds or more but less than 8 seconds.
C: The Gurley value was 8 seconds or more.

Next, an image was recorded by using an inkjet recording apparatus equipped with a liquid absorbing member having the porous body obtained as above. A transfer-type inkjet recording apparatus illustrated in FIG. 4 was used as the inkjet recording apparatus.

First, a reaction liquid was applied to the transfer body 101 by using the reaction liquid applying device 103. Then, the ink applying device (inkjet device) 104 applies an aqueous ink to the transfer body 101 to which the reaction liquid had been applied, so as to form an intermediate image on the transfer body 101. Next, a member prepared by stacking a polypropylene porous film (thickness: 30 μm, average pore diameter: 8.0 μm, a Gurley value: 0.2 seconds) serving as a supporting layer on a first porous layer-side surface of the porous body was used as the liquid absorbing member 105a of the liquid absorbing device 105. The second porous layer-side surface of the porous body of the liquid absorbing member was caused to abut against the intermediate image so that the liquid component contained in the intermediate image is absorbed by the liquid absorbing member 105a and the liquid component was removed from the intermediate image.

Next, the intermediate image from which the liquid component in the ink had been removed was caused to contact the record medium 108 so that the intermediate image was transferred from the transfer body 101 to the record medium 108 and a print product, which was a record medium with an image formed thereon, was obtained.

A cylindrical-shaped drum composed of an aluminum alloy was used as the supporting member 102 that supported the transfer body 101 from the viewpoints of the required properties, such as the dimension accuracy and stiffness that withstands pressure during transferring, as well as reducing the inertia of rotation to improve the control responsiveness. A PET sheet having a thickness of 0.5 mm coated with a 0.2 mm-thick silicone rubber (KE12 produced by Shin-Etsu Chemical Co., Ltd.) having a rubber hardness of 40° was used as the transfer body. The surface of the transfer body was plasma-treated with an atmospheric pressure plasma treatment apparatus produced by Sekisui Chemical Company, Limited at an irradiation distance of 1.0 mm, power of 380 W, a frequency of 10 kHz, and a processing speed of 200 mm/min. As a result, a transfer body 101 having a surface energy of 30 mN/m was obtained.

The obtained transfer body 101 was fixed to a supporting member by using a double-stick tape.

In this example, a roller-type reaction liquid applying device 103 was installed as a device that applies a reaction liquid. In this manner, the reaction liquid was continuously applied to the surface of the record medium. The reaction liquid had the following composition, and the application amount was 1 g/m².

### Preparation of Reaction Liquid

The following components were mixed and thoroughly stirred. The resulting mixture was pressure-filtered with a cellulose acetate filter (produced by Advantech Co., Ltd.) having a pore size of 3.0 μm to prepare a reaction liquid.

Levulinic acid: 40.0 parts

Glycerin: 5.0 parts

MEGAFACE F444: 1.0 part (surfactant produced by DIC Corporation)

Ion exchange water: 54.0 parts

The ink applied to the transfer body 101 from the inkjet head 104 reacted with the component in the reaction liquid already applied, and the coloring material component and the like became coagulated. As a result, an intermediate image formed by an ink having an increased viscosity was formed.

In this example, a device of a type that ejects the ink by an on-demand system using an electric-thermal converter element was used. The inkjet device was an inkjet head of a line head type in which ink ejection ports were aligned in a direction perpendicular to the conveying direction of the record medium (the direction orthogonal to the plane of the paper of the drawing).

The dot density was 1200 dpi×1200 dpi, and printing was performed so that the maximum ink liquid amount was 20 g per square meter.

The constituent materials of the ink and the ink composition are indicated below.

### Preparation of Resin Particles

Into a four-necked flask equipped with a stirrer, a reflux cooling device, and a nitrogen gas inlet tube, 18.0 parts of butyl methacrylate, 2.0 parts of polymerization initiator (2,2′-azobis(2-methylbutylonitrile)), and 2.0 parts of n-hexadecane were placed, nitrogen gas was introduced to the reaction system, and stirring was performed for 0.5 hours. To the flask, 78.0 parts of a 6.0% aqueous solution of an emulsifier (NIKKOL BC15 produced by Nikko Chemicals Co., Ltd.) was added dropwise, followed by stirring for 0.5 hours. Next, ultrasonic waves were applied from an ultrasonic wave irradiator for 3 hours to emulsify the mixture. Subsequently, a polymerization reaction was conducted at 80° C. for 4 hours in a nitrogen atmosphere. After the reaction system was cooled to 25° C., the components were filtered, an appropriate amount of pure water was added, and a water dispersion of resin particles 1 having a resin particle 1 (solid) content of 20.0% was obtained thereby.

A water dispersion of resin particles 2 having a resin particle 2 (solid) content of 20.0% was prepared as with the preparation of the resin particles 1 except that butyl methacrylate was changed to ethyl methacrylate.

### Preparation of Resin Aqueous Solution

A styrene-ethyl acrylate-acrylic acid copolymer (resin 1) having an acid value of 150 mgKOH/g and a weight-average molecular weight of 8,000 was prepared. An aqueous solution of the resin 1 having a resin (solid) content of 20.0% was prepared by neutralizing 20.0 parts of the resin 1 with potassium hydroxide equimolar to the acid value of the resin 1 and adding an appropriate amount of pure water.

The resin 1 was changed to a styrene-butyl acrylate-acrylic acid copolymer (resin 2) having an acid value of 132 mgKOH/g, a weight-average molecular weight of 7,700, and a glass transition temperature of 78° C. An aqueous solution of the resin 2 having a resin (solid) content of 20.0% was prepared as with the preparation of the aqueous solution of the resin 1 except for the above-described change.

### Preparation of Pigment Dispersion

A pigment (carbon black) in an amount of 10.0 parts, the aqueous solution of the resin 1 in an amount of 15.0 parts, and pure water in an amount of 75.0 parts were mixed. The mixture and 200 parts of zirconia beads having a diameter of 0.3 mm were placed in a batch-type vertical sand mill (produced by AIMEX CO., Ltd.), and the resulting mixture was dispersed for 5 hours under water cooling. Subsequently, coarse particles were removed by centrifugal separation, and the resulting product was pressure-filtered with a cellulose acetate filter (produced by Advantech Co., Ltd.) having a pore size of 3.0 μm so as to prepare a pigment dispersion K having a pigment content of 10.0% and a resin dispersant (resin 1) content of 3.0%.

### Preparation of Ink

The following components were mixed and thoroughly stirred. The resulting mixture was pressure-filtered with a cellulose acetate filter (produced by Advantech Co., Ltd.) having a pore size of 3.0 μm to prepare an ink. Acetylenol E100 is a surfactant produced by Kawaken Fine Chemicals Co., Ltd.

Pigment dispersion K: 20.0 parts

Water dispersion of resin particles 1: 50.0 parts

Aqueous solution of resin 1: 5.0 parts

Glycerin: 5.0 parts

Diethylene glycol: 7.0 parts

Acetylenol E100 (surfactant produced by Kawaken Fine Chemicals Co., Ltd.): 0.5 parts

Pure water: 12.5 parts

Subsequently, the liquid absorbing member 105a of the liquid absorbing device 105 was caused to pressure-contact the intermediate image so as to absorb the liquid component contained in the ink on the transfer body 101. The liquid absorbing member 105a is pressure-contacted against the transfer body 101 by the pressing member for the liquid absorbing member not illustrated in the drawing. The transfer body 101 is conveyed by a transfer body conveying roller (not illustrated), and, in synchronization, the liquid absorbing member 105a is adjusted by a liquid absorbing member conveying roller so that the speed is the same as the intermediate transfer body 101. In this example, the transfer body conveying speed was set to 0.5 m/second.

The liquid absorbing member 105a was immersed in a treatment liquid composed of 95 parts of ethanol and 5 parts of water to allow penetration, and then the treatment liquid was substituted by a liquid composed of 100 parts of water. The liquid absorbing member 105a was then used to remove the liquid component. The liquid absorbing member was each caused to abut against the image on the transfer body at a pressure of 1 kg/cm² for 20 ms.

The liquid absorbing member 105a that had absorbed the liquid component from the ink image was conveyed by the liquid absorbing member conveying roller, and the absorbed liquid component was recovered by an absorbed liquid recovering device not illustrated in the drawing.

In this example, Aurora coated paper (produced by Nippon Paper Group, Inc., 127.9 g/m²) was used as the record medium 108.

The image formed on the record medium is evaluated on the basis of the following standards related to the amount of coloring material movement in an end portion of the image (smeared image). The smaller than amount of the coloring material movement, the higher the image quality.

A: No smeared image was observed despite repeated use.
B: Slight smeared image was observed, but the extent of the smeared image was negligible.
C: Extensive smeared image was observed.

TABLE 3

| | Mechanical strength | | Gurley | Smeared |
|---|---|---|---|---|
| | (kg/cm²) | Evaluation | value | image |
| Example 1 | 9.7 | A | A | A |
| Example 2 | 8.5 | A | A | A |
| Example 3 | 9.6 | A | A | A |
| Example 4 | 9.7 | A | A | A |
| Example 5 | 9.5 | A | A | A |
| Example 6 | 9.7 | A | A | A |
| Example 7 | 10.9 | A | A | A |
| Example 8 | 5.8 | B | A | A |
| Example 9 | 9.4 | A | B | B |
| Example 10 | 9.5 | A | A | B |
| Comparative Example 1 | 0.2 | C | A | A |
| Comparative Example 2 | 10.0 | A | C | C |
| Comparative Example 3 | 0.1 | C | A | A |
| Comparative Example 4 | 9.8 | A | C | C |
| Comparative Example 5 | 9.8 | A | C | C |
| Comparative Example 6 | 0.1 | C | A | A |

While the present disclosure has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2018-163657, filed Aug. 31, 2018, which is hereby incorporated by reference herein in its entirety.

What is claimed is:

1. A method for producing a porous body that includes a first porous layer and a second porous layer on the first porous layer, the method comprising:
forming a composite fiber aggregate by an electrospinning method, the composite fiber aggregate having a first fiber containing a first resin and a second fiber containing a second resin having a softening point lower than a softening point of the first resin;
after forming the composite fiber aggregate, performing a first heat treatment on the composite fiber aggregate;
after performing the first heat treatment, forming, by an electrospinning method, a fiber aggregate on the composite fiber aggregate subjected to the first heat treatment, the fiber aggregate containing the second resin; and
after forming the fiber aggregate, performing a second heat treatment on a multilayer body that includes the composite fiber aggregate subjected to the first heat treatment and the fiber aggregate,
wherein a volume ratio of the first resin to the second resin in the first porous layer is 1:1 to 200:1,
a heating temperature in the performing of the first heat treatment is higher than or equal to the softening point of the first resin, and
a heating temperature in the performing of the second heat treatment is higher than or equal to the softening point of the second resin but lower than the softening point of the first resin.

2. The method according to claim 1, wherein the performing of the first heat treatment comprises subjecting the composite fiber aggregate to a pressurizing treatment.

3. The method according to claim 1, wherein the performing of the second heat treatment comprises subjecting the multilayer body to a pressurizing treatment.

4. The method according to claim 1, wherein a difference between the softening point of the first resin and the softening point of the second resin is 10° C. or more.

5. The method according to claim 1, wherein the volume ratio of the first resin to the second resin in the first porous layer is 2:1 to 100:1.

6. The method according to claim 1, wherein the first resin has a tensile modulus of 1500 MPa or more.

7. The method according to claim 1, wherein the second resin contains a fluororesin.

8. A porous body comprising:
a first porous layer; and
a second porous layer on the first porous layer,
wherein the porous body is obtained by:
forming a composite fiber aggregate by an electrospinning method, the composite fiber aggregate having a first fiber containing a first resin and a second fiber containing a second resin having a softening point lower than a softening point of the first resin;
after forming the composite fiber aggregate, performing a first heat treatment on the composite fiber aggregate;
after performing the first heat treatment, forming, by an electrospinning method, a fiber aggregate on the composite fiber aggregate subjected to the first heat treatment, the fiber aggregate containing the second resin; and
after forming the fiber aggregate, performing a second heat treatment on a multilayer body that includes the composite fiber aggregate subjected to the first heat treatment and the fiber aggregate, and
wherein a volume ratio of the first resin to the second resin in the first porous layer is 1:1 to 200:1,
a heating temperature in the performing of the first heat treatment is higher than or equal to the softening point of the first resin, and
a heating temperature in the performing of the second heat treatment is higher than or equal to the softening point of the second resin but lower than the softening point of the first resin.

9. An inkjet recording apparatus comprising:
an image forming unit that forms a first image on an ejection-receiving medium, the first image containing a liquid component and a coloring material; and
a liquid absorbing member including a porous body, and absorbing at least part of the liquid component from the first image by bringing the porous body into contact with the first image,
wherein the porous body includes:
a first porous layer; and
a second porous layer on the first porous layer,
wherein the porous body is obtained by:
forming a composite fiber aggregate by an electrospinning method, the composite fiber aggregate having a first fiber containing a first resin and a second fiber containing a second resin having a softening point lower than a softening point of the first resin;
after forming the composite fiber aggregate, performing a first heat treatment on the composite fiber aggregate;
after performing the first heat treatment, forming, by an electrospinning method, a fiber aggregate on the composite fiber aggregate subjected to the first heat treatment, the fiber aggregate containing the second resin; and
after forming the fiber aggregate, performing a second heat treatment on a multilayer body that includes the composite fiber aggregate subjected to the first heat treatment and the fiber aggregate, and
wherein a volume ratio of the first resin to the second resin in the first porous layer is 1:1 to 200:1,
a heating temperature in the performing of the first heat treatment is higher than or equal to the softening point of the first resin, and
a heating temperature in the performing of the second heat treatment is higher than or equal to the softening point of the second resin but lower than the softening point of the first resin.
